(19) United States
(12) Patent Application Publication
(10) Pub. No.: US 2008/0141532 A1
(43) Pub. Date: Jun. 19, 2008

(54) Manufacturing Process for a Tubeless Wheel Rim for Off Road Vehicles, Rim Obtained Through an Off-Road Vehicle Process

(76) Inventor: Francisco Antonio de Souza Manso, Lorena (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/928,129

(22) Filed: Oct. 30, 2007

(30) Foreign Application Priority Data
Oct. 30, 2006 (BR) PI0604498-0

(51) Int. Cl. B21K 1/38; B23K 28/02

(52) U.S. Cl. 29/894.35; 228/170

(57) ABSTRACT

The current invention refers to the manufacturing process of rims for tubeless wheels for “off road” vehicles which, amongst other advantages, are far simpler when compared to the existing processes, presents a reduced number of operations and permits the use of lower grade raw materials in the manufacturing process without compromising on the final quality of the rim. According to the invention, the rim may be obtained from a single, mechanically shaped part, through drawing. Still according to the invention, the rim may be substituted with by parts, the first part being mechanically shaped through drawing and the second part through stamping. Alternatively, the two parts may be mechanically shaped through drawing.

Rims obtained through the referred to processes and the tubeless wheels for “off road” vehicles built with the referred to rims are also objects of the invention.

### FIELD OF INVENTION

This invention refers to the manufacturing process of rims for wheels without tubes in “off road” vehicles, the rims obtained through these processes, as well as the wheels of “off road” vehicles, which encompasses the referred to rims.

### DESCRIPTION OF THE TECHNICALITIES

Classified as “off road” vehicles are all those pieces of equipment that are, motorized, low speed, destined for extra heavy work in loading, offloading, transport and operation, such as the known graders, front-end loaders, telescopic handlers, backhoes, among others.

The “off road” vehicles use tubeless steel wheels, usually called multipart, as they are composed of the rim, safety hoops, disc and rubber o-ring for sealing.

The “off road” rim manufacturing process making up the wheel is craft-work or low production. The rim may be made up of a hot laminated profile equipped with a region of channels (“gutter”), which is welded to a cylindrical segment (strip), which in its turn is welded to a flange, thus configuring the rim made up of three parts. It may also be made up of a “gutter” welded directly to a flange, thus configuring the rim made up of two parts.

The manufacturing process steps are different for each part making up the rim. The “gutter” is rolled, welded and deburred starting with a hot laminated profile of better quality steels. The strip is made up of a bulk piece (“blank”) and is rolled, welded and deburred. The flange is usually made through a stamping process. For some wheel dimensions the rim may as has already been mentioned be made up of two parts with these being only the “gutter” and flange, with the due dimensions being compensated, but maintaining the same manufacturing process. The safety ring's seating and “o-ring” “gutters are machined after” the final assembly of the wheel, or may even be incorporated into the laminated profile itself.

These known processes present a number of disadvantages, as for example, the fact that it deals with crafting manufacture, with low production, due to the handling of a number of components and the high number of operations in each one. Besides this the cost of the hot laminated profile, which is used in the “gutter” region is far higher and it must be from a better quality steel (SAE 1025 steel), as it is in the region with the greatest stress on the rim. The “gutter”, when it has the safety and o-ring channels “gutter” on the profile itself, requires special deburring and sanding operations to remove the excessive material arising from the autogenous welding from the top with fusing anticipating the electric current (“flash welding”). When there are no such channels these must be made in specific machining operations, with the same low production and difficult adjustment.

The assembly of the components is another problem, as the weld creates a thermally affected zone, which changes the properties of the materials adjacent to the joins and affects the resistance of the unit, especially in the strip to “gutter” junction. The dimensional tolerances for this type of rim are also always greater due to the sub-mounts of the components, a factor which mainly affects the lateral and radial alignment deviation of these wheels. Finally the weight of these wheels with the current technology is highly affected by the type of material employed and through the absence in the thickness variation in the necessary locations. Consequently the final cost of the wheel is high to cover its low productivity, too many operations, raw materials and labor involved in the current rim manufacturing process.

A document for the current technology that has some relation with the object of this invention is U.S. Pat. No. 3,926,025. The technique described in this patent is therefore different, constituting in a single rim manufacturing process for wheels with tubes for trucks. In it the so called “gutter” region is made in a strip process and presents a single cavity with a complementary depression for the seating of the ring or rings.

### THE INVENTION'S OBJECTIVES

The objective of this invention is to afford a semi-automatic process for the manufacture of rims, rim segments and flanges for steel wheels, multiparts and without tubes for “off road” vehicles, which may overcome all of the disadvantages discussed herein in relation to current technology. The main advantages of the manufacturing process herein proposed are:
reduction in the number of necessary operations for the manufacture of “off road” rims;
eliminates welding between components (“gutter”/strip) and consequently eliminates the thermally affected zone which prejudices the mechanical properties of the material;
eliminates the need for sanding the rim's channels “gutter” after deburring;
eliminates the need for machining the rim's channels “gutter” after assembling the wheel;
draws out the material and consequently its hardening, also in the region of the rim's body, resulting in superior mechanical properties compared to the current technological process;
improves the dimensional tolerances of the wheel set;
reduces the component's weight;
optimizes the use of the materials, varying the thickness over the rim's profile or rim section;
uses lower quality materials in manufacturing the “gutter”, replacing the current hot laminated profile SAE 1025 steel for the SAE 1010.
raises the mechanical characteristics of the material due to the hardening process resulting from the drawing and laminating process;
diminishes the lateral and radial alignment deviations of the wheel set; and
diminishes the final suspended mass of the off road vehicle.

As an additional advantage it is worth mentioning that the metallographic analysis of the rim's profile has shown that the drawing combined with the lamination allows for a diminishing in the size of the material's grain at its structure level, which results in a more homogenous structure and far more resistant.

It is also the objective of the invention to furnish a rim for tubeless wheels for “off road vehicles”, which is obtained through the manufacturing process here described, and that it encompasses all of the advantages listed above, as well as provide a tubeless wheel for an “off road” vehicle, which encompasses the said rim.

### A BRIEF DESCRIPTION OF THE INVENTION

The objectives of the invention are achieved through the provision of a manufacturing process of a rim for a tubeless wheel for an “off road” vehicle, the rim being constituted of a single piece mechanically formed through drawing.

The objectives of the current invention is achieved through the provision of a manufacturing process of a rim for a tubeless wheel for an “off road” vehicle, the rim being made up of two parts, the first part being mechanically shaped through drawing and the second part being mechanically shaped through stamping.

The objectives of the invention are also achieved through the provision of a manufacturing process of a rim for a tubeless wheel on an “off road” vehicles, the rim being made up of two parts mechanically shaped through drawing.

Finally the objectives of the invention are achieved through rims obtained by the referred to processes of tubeless wheels for “off road” vehicles, constructed with the referred to rims.

### SUMMARIZED DESCRIPTION OF THE DRAWINGS

This invention will next be described in detail based on the execution examples represented in the drawings. The figures show:

FIG. 1—is a view in perspective of a complete multipart wheel (rim, rings, disc and “driver”);

FIG. 2—is a profile view of a rim fitted with three components (flange, strip and “gutter”) with the current technology; and

FIG. 3—is a profile view of a rim fitted with two components (flange and “gutter”), also with the current technology.

FIGS. 4 to 8 show the sequence of conformances applied to a profile for obtaining a single piece rim, according to the invention. The figures show:

FIG. 4—a sectioned view of the bulk part “blank”, which is rolled into a cylindrical shape;

FIG. 5—a sectioned view of the “blank” with the shaped “gutter” and with greater thickness in the “gutter” region;

FIG. 6—rest of the drawn rim's body with the seating region of the pre-formed tire's “bead seat”;

FIG. 7—rim profile with the drawn flange;

FIG. 8—rim profile after the last lamination operation of the “o-ring” channel “gutter” and the final form of the “bead seat”.

The sets of figures from 9 to 13 and 14 to 17 respectively illustrates the shaping steps of the rim's segment and flange, for a rim composed of two parts, according to the invention. The figures show:

FIG. 9—a sectioned view of the “blank”, which is rolled into the cylindrical shape, starting the shaping of the rim's segment;

FIG. 10—the profile of the rim's segment with the shaped “gutter”, presenting a greater thickness in its region;

FIG. 11—the body of the drawn rim's segment;

FIG. 12—rim segment after the “o-ring” channel lamination operation;

FIG. 13—rim segment after the last machining operation the weld joint;

FIG. 14—sectioned view of the “blank”, which is rolled in a cylindrical shape and which gives rise to the rim's flange;

FIG. 15—the drawn flange body, with the preformed “bead seat”;

FIG. 16—drawn flange; and

FIG. 17—the shaped “bead seat” and the last machining operation carried out on the welded joint.

FIG. 18—shows the final profile of the complete rim after the joint welding operation;

FIG. 19—shows the detailed “gutter” formed according to this invention;

FIGS. 20 and 21—comparatively illustrates the rim profiles of the previous technique (made up of two parts—FIG. 20) and the invention (made up of one part—FIG. 21);

FIGS. 22 and 23—comparatively illustrates the rim profiles of the previous technique (made up of three parts—FIG. 22) and the invention (FIG. 23);

FIG. 24—schematically shows the manufacturing process of the rim with current technology, with two components, with the complementary operation after assembling the wheel (machining the “gutter's” channels);

FIG. 25—schematically shows the manufacturing process of the rim, through drawing, into a single component, according to this invention;

FIG. 26—schematically shows the manufacturing process of the rim with current technology, with three components, with the complementary operation after assembling the wheel (machining the “gutter's” channels);

FIG. 27—schematically shows the manufacturing process of the rim with two components, with the drawn rim and stamped flange, according to this invention; and

FIG. 28—schematically shows the manufacturing process of the rim with two components with this invention, being drawn rim and drawn flange.

### DETAILED DESCRIPTION OF THE FIGURES

Only for illustration purposes, FIG. 1 shows a view in perspective of a complete multipart wheel, encompassing a rim, rim 1, rings “o-ring” and safety ring 3, disc 4 and “driver” 2.

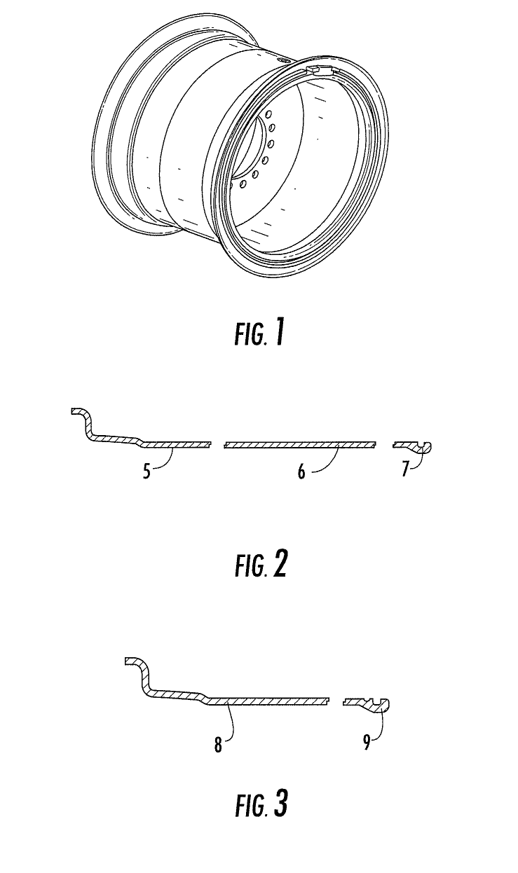

FIGS. 2 and 3 show the profiles of conventional multipart rims. FIG. 2 shows a three part rim, with the parts being flange 5, strip 6 and the “gutter” 7. FIG. 3 shows a two part rim, with the parts being flange 8 and the “gutter” 9.

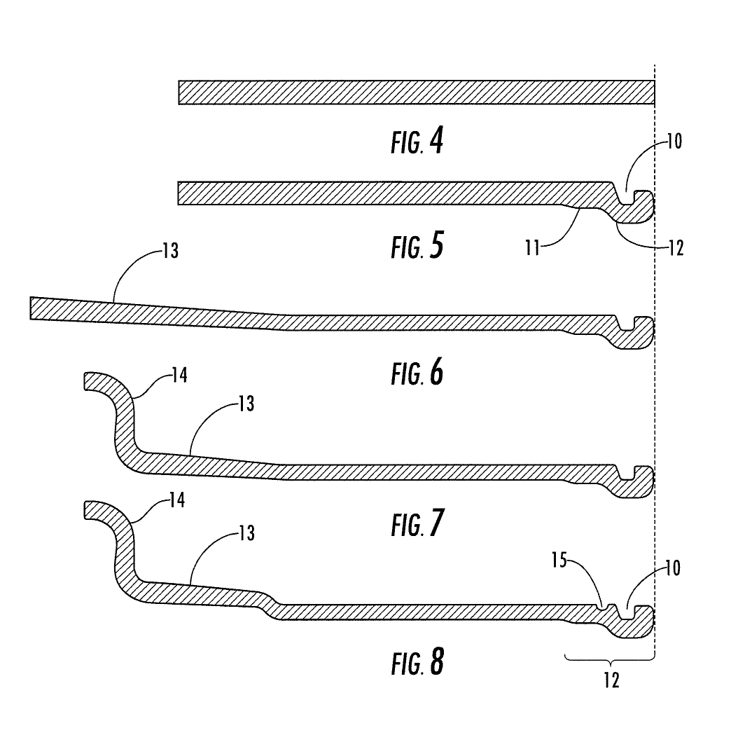

FIGS. 4 to 8 describe the sequence of mechanical shaping carried out to obtain a single piece rim, according to the current invention.

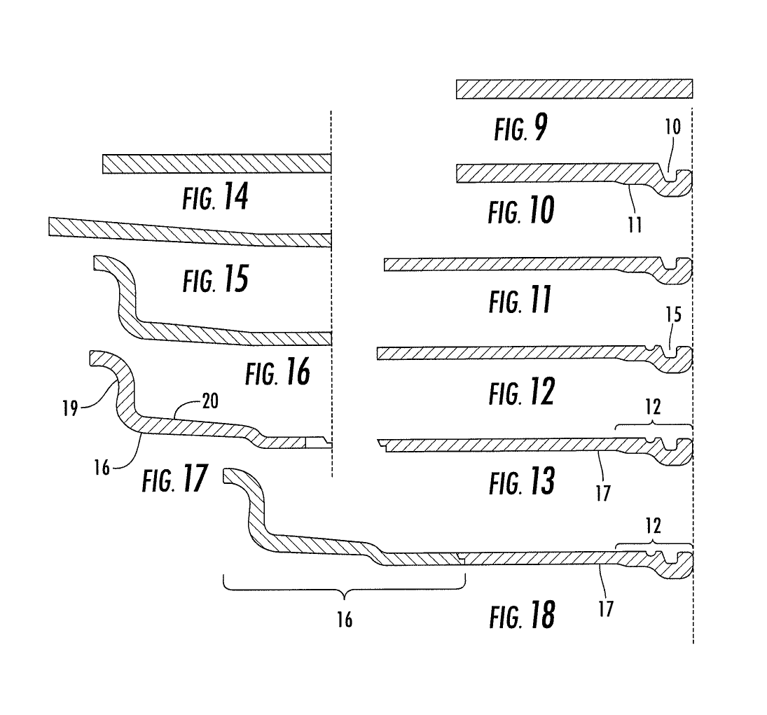

According to the invention, to obtain a single piece rim, a SAE 1010 steel blank is split, which is rolled, welded, deburred and gauged (FIG. 4), then sent to the drawing phases. From there, initially the seating channel 10 for the safety ring is drawn (FIG. 5), through the combined actions of internal and external rollers of the manufacturing equipment (not shown). In the same operation due to the movement of the material “blank”, a greater thickness (reinforced region) 11 is concentrated next to the seating channel 10, this region is called the “gutter” 12 and which supports the greatest working stresses. In the following phase (FIG. 6), the rest of the rim's body is drawn, with the purpose of controlling the thickness that will be typical for the profile, achieving more than 30% reduction compared to the original raw material. As a result, in this same phase, the central region for the rim is drawn as well as the pre-forming the tire's “bead seat” seating region 13, only through the release of pressure by the rollers of the production equipment at the end of travel. In an adjacent operation with the rim in an inverted position, the internal and external rolls work in the region of the “bead seat” 13, raising the flange 14 (FIG. 7). In a last step and forming the ring channel for the “o-ring” 15 through a lamination process. This “o-ring” channel 15 is strictly dimensioned and given error allowance through international TRA and EUWA regulations. Simultaneously during this last operation the “bead seat” 13 is lifted to its final shape.

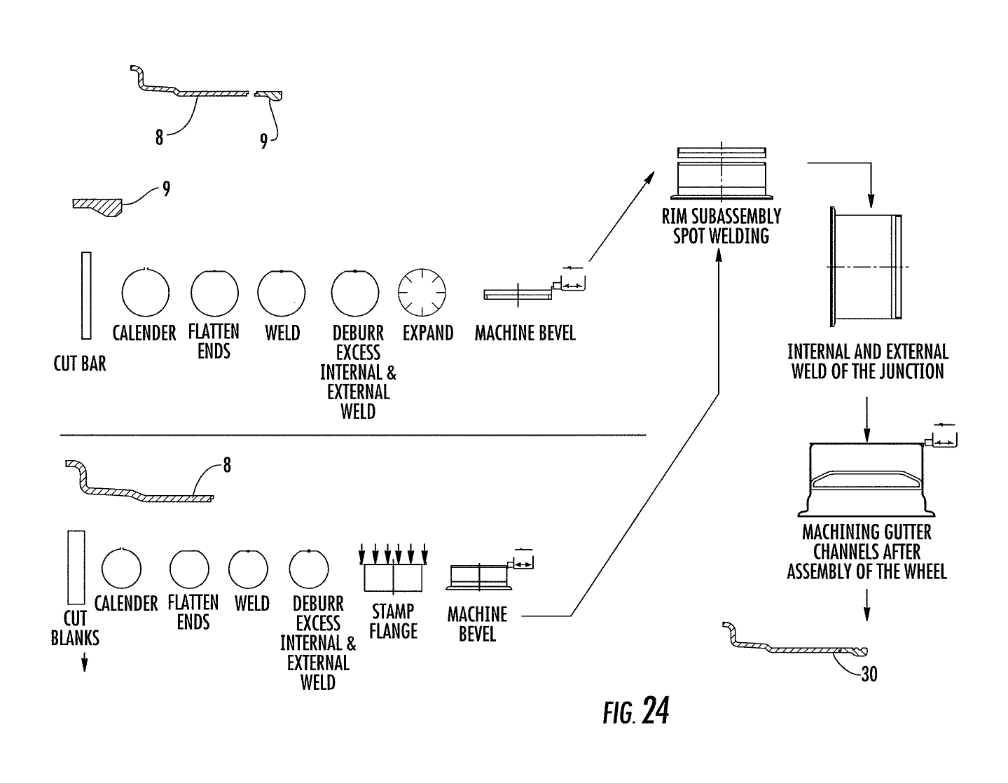

Once the process has terminated, a single piece rim is obtained, drawn, without unstable regions due top the elimination of the thermally affected region resulting from the welding between the flange and “gutter” (FIGS. 20 and 24), more resistant even with the use of lower grade materials, due to the hardening, which the drawing process affords; with superior dimensional and characteristics and tolerances; lighter and with the optimized use of raw materials, which allows for the allocation of greater thicknesses only in the areas that are most needed by the rim; with better deviation of the radial and lateral alignment of the wheel set, lower suspended mass and consequently better vehicle drivability.

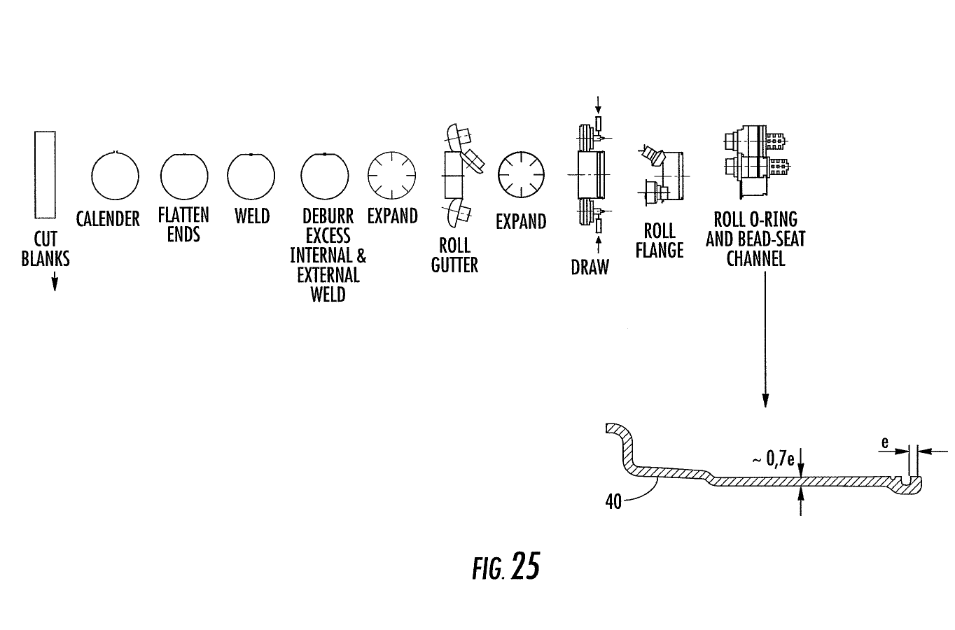

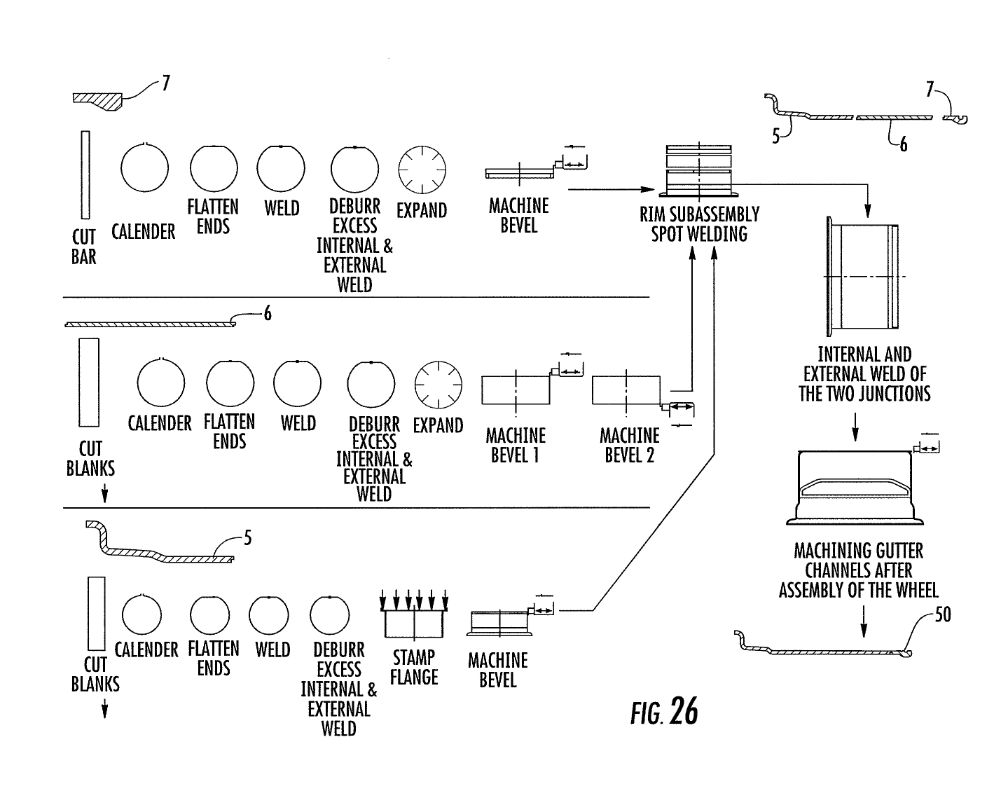

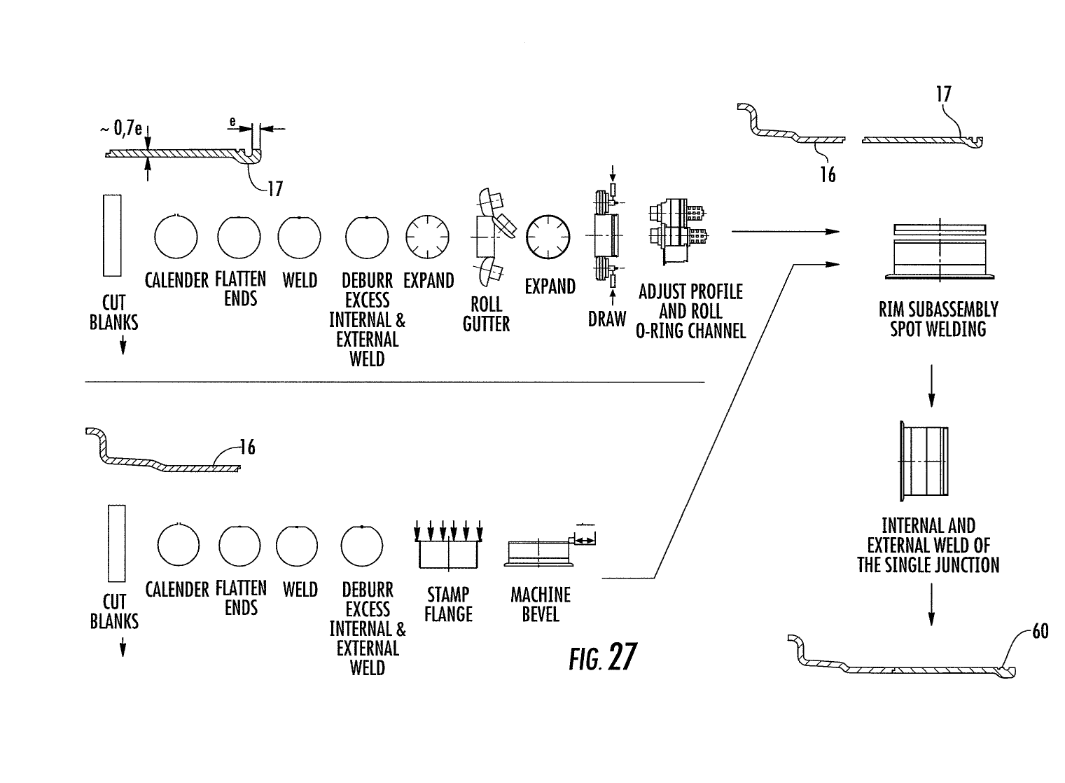

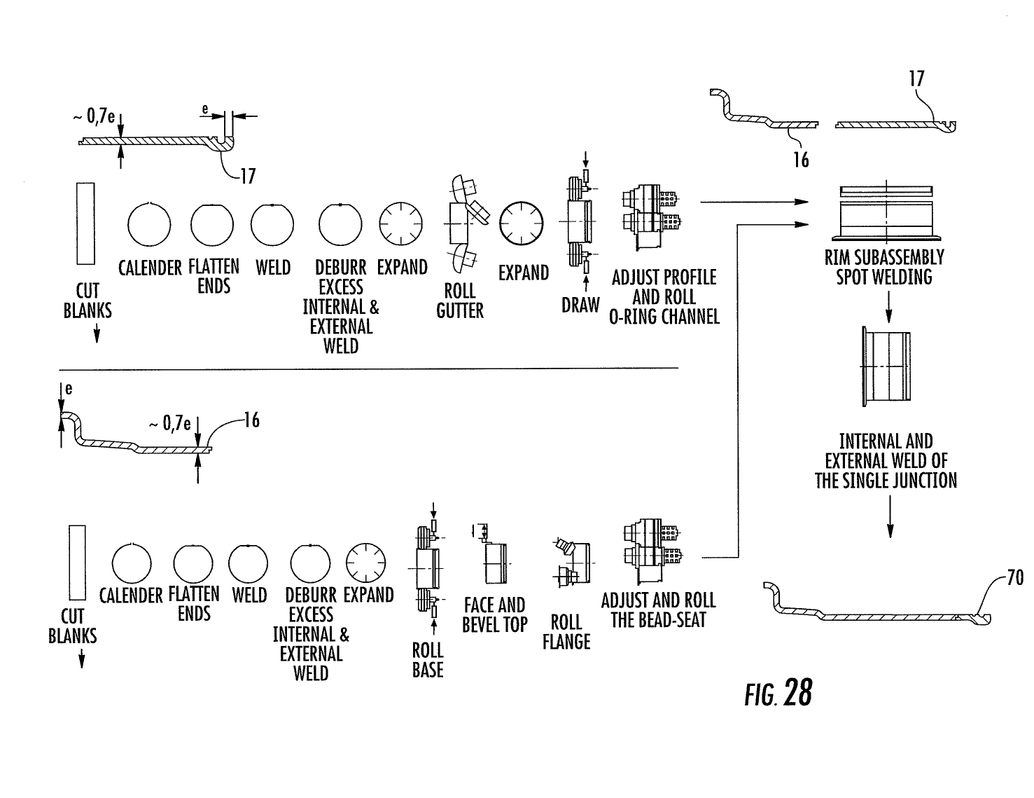

FIG. 25 schematically shows the process herein proposed to obtain a single profile drawn rim 40, particularly applicable to wheels of the 10 VA×24 size. FIG. 24 schematically shows the process with current technology to obtain a profile of a multipart rim, composed of two parts 8, 9, with them being “gutter” 9 and the stamped flange 8, both welded to form the final profile 30.

Rims for “off road” vehicles, three component multiparts (FIGS. 2 and 22) may according to the current invention, be manufactured in two parts, with them being one section 16 containing the flange 19 (the second rim segment 16) and a rim segment 17 (first rim segment 17) (FIG. 23). As described above in relation to FIGS. 4 to 8, this rim segment 17 is manufactured through the same innovative process, except that it deals with a smaller “blank” and consequently, through the formation in the region of the “bead seat”. As a last operation in this rim segment 17, after drawing the body and laminating the “o-ring” channel 15, one has to machine the welded joint 18 on the opposite side to the “gutter” 12. Also valid are all of the listed advantages for the full rim (single drawn profile), in this one with all of the gains being more evident in relation to the old process, as for example: a reduction in thickness at some points by over 30%; the final width of the component by 28% greater than when compared to the original “blank” and still, in some models, the rim's final weight, when welded to a stamped flange, and in the order of 8% smaller than the model of the same dimension manufactured using the old process (multipart rim with three parts). FIGS. 9 to 13 illustrate the shaping steps of the rim segment 17, with them being: “blank” section in SAE 1010 steel, rolled into a cylindrical shape of the rim 17 (FIG. 9); rim segment profile with the formed “gutter” 12, presenting greater thickness 11 in its proximity (FIG. 10); drawn rim body segment (FIG. 11); rim segment after the “o-ring” 15 channel lamination operation (FIG. 12); and rim 17 segment after the last machining operation of the welded joint 18 (FIG. 13).

The shaping of section 16 containing the flange 19 may be carried out through stamping or drawing (FIGS. 14 to 17). In the case of stamping, section 16 part of a steel “blank”, which is rolled, welded, deburred and gauged. In these complementary steps of the process, a stamping option to form the region called the “bead seat” 20, simultaneously the preforming of flange 19, an additional stamping operation for the final shape of the flange 19 and another final gauging step in laminating. It is also possible to shape the flange in one single stamping operation. At the extreme opposite of the flange 19 the welded joint is machined 21, which will be the joining region with the rim segment 17.

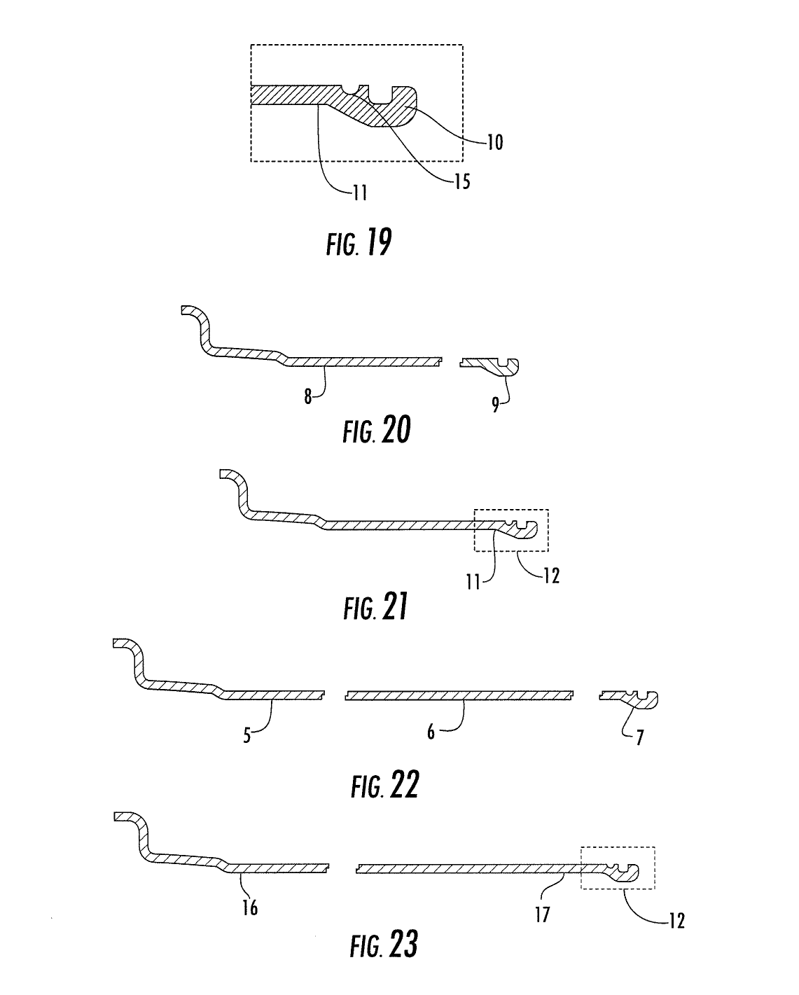

Alternatively, according to the invention, section 16 containing the flange 19 may be shaped through drawing. In this process starting with a steel “blank” (FIG. 14), which is rolled, welded, deburred and gauged, from there going on to the drawing stages. Initially, the body region is drawn for the flange segment as well as the preformation of the “bead seat” (FIG. 15). In the adjacent operation, with the rim in the inverse position, internal and external rolls in the manufacturing equipment (not shown) work in the region of the “bead seat”, raising the flange 19 (FIG. 16). An additional operation gauges the segment (portion 16) and takes the “bead-seat” 20 to its final shape (FIG. 17). At the extreme opposite to the flange 19 the machining of the welded joint is carried out 21, which will be in the joint region with the rim's segment 17.

With portion 16 containing the flange 19 and rim segment 17 finished, then it is mounted and the joint between them is welded 22, forming the final rim which will be the integral part of multipart wheels for “off road” vehicles.

FIG. 27 schematically shows the process here proposed to obtain a rim 60 made up of two parts, with the rim segment 17 being drawn and portion 16 containing the flange 19 being stamped, welded to each other. FIG. 28 also shows schematically the process herein proposed to obtain a rim 70 made up of two parts, with the rim segment 17 being drawn and portion 16 containing the flange 19 also drawn. The processes illustrated in FIGS. 27 and 28 are particularly applicable to wheel sizes 14×25/1.4 and 17×25/1.7. FIG. 26 schematically shows the process with current technology to obtain a multipart rim profile, made up of three parts, with them being the “gutter” 7, strip 6 and flange 5, with this last mentioned being stamped, all of them welded to form the final profile 50. FIGS. 25, 27 and 28 also illustrate the variations in thickness of the parts making up the rim, with the thickness in the strip region being 0.7 times the value of the thickness at the end of the “gutter”.

Once the process has been terminated for wheels with larger dimensions, one has a two part rim, with only one thermally affected zone 22 and far from the region with the greatest stresses 12 (FIG. 18), more resistant even with lower grade materials, as mentioned before; with far superior dimensional characteristics and tolerances; lighter due to the optimized use of raw materials and manufactured with far less steps in relation to the process with current technology. Finally, this rim also affords better lateral and radial alignment deviations of the wheel set, lower suspended mass and consequently better drivability of the vehicle.

Having described the preferred example, it must be understood that the scope of the current invention also covers other possible variations, with it only being limited by thought, here included the possible equivalents.

1. Manufacturing process of the tubeless wheel rim for “off road” vehicles characterized by the fact of it encompassing the following steps:
a) cutting the blank from steel;
b) rolling, welding, deburring and gauging the blank to form the rim;
c) drawing the part to form a seating channel (10) a safety ring, forming a region of greater thickness (11) adjacent to the seating channel (10);
d) drawing of the rim's central region and preforming the seating region for the tire's bead seat (13);
e) drawing the tire's bead seat region (13), with the final forming of the tire's bead seat region (13) and the forming of a flange (14) at the extreme opposite end which contains the seating channel (10); and
f) machining of a seating channel for an “o-ring” (15) in the region adjacent to the seating channel (10) for the safety ring.

2. Process according to claim 1, characterized by the fact that, in drawing the part in step (d), there is a reduction in the thickness of the part by around 30% in relation to the initial blank.

3. Process according to claim 1, characterized by the fact that the blank is SAE 1010 steel.

4. Manufacturing process of the tubeless wheel rim for “off road” vehicles characterized by the fact of it encompassing the following steps:
a) cutting the blank from steel;
b) rolling, welding, deburring and gauging the blank form the first rim segment (17);
c) drawing of the first segment of the rim to form a seating channel (10) for a safety ring, forming a region of greater thickness (11) adjacent to the seating channel (10);
d) machining of the welded joint (18), at the extreme opposite end which contains the seating channel (10);
e) cutting of a second blank from steel;
f) rolling, welding, deburring and gauging the blank to form the second rim segment (16);
g) at least one stamping operation of the rim's second segment (16) for the forming of the tire's bead seat region (20) and for the forming of a flange (19);
h) gauging of the rim's second segment (16) through a lamination process;
i) machining the welded joint (21) at the extreme opposite end containing the flange (19); and
j) mounting and welding the welded joints (18, 21) of the rim's first and second segments (16, 17).

5. Process according to claim 4, characterized by the fact that step (g) is split up between a first stamping operation of the rim's second segment (16) for the preformation of the tire's bead seat region (20) and for the preformation of a flange (19), and a second stamping operation for the final forming of the tire's bead seat region (20) and of the flange (19).

6. Process according to claim 4, characterized by the fact that the obtained rim has regions with a reduced thickness of around 30% and an increase in width of around 28% when compared to the initial blanks.

7. Process according to claim 4, characterized by the fact that the blanks are from SAE 1010 steel.

8. Manufacturing process of the tubeless wheel rim for “off road” vehicles characterized by the fact of it encompassing the following steps:
a) cutting the first blank from steel;
b) rolling, welding, deburring and gauging the blank to form of the first rim segment (17);
c) drawing the rim segment to form a seating channel (10) for a safety ring, forming a region of greater thickness (11) adjacent to the seating channel (10);
d) machining of the welded joint (18), at the extreme opposite end which contains the seating channel (10);
e) cutting the second blank from steel;
f) rolling, welding, deburring and gauging the blank to form of the second rim segment (16);
g) drawing the rim's second segment (16) to perform the tire's bead seat region (20);
h) drawing the rim's second segment (16) to form a flange (19);
i) gauging of the rim's second segment (16) through a lamination operation and final forming of the tire's bead seat region (20);
j) machining of a welded joint (21) at the extreme end containing the flange (19); and
k) mounting and welding of the welded joints (18, 21) of the first and second rim segments (16, 17).

9. Process according to claim 8, characterized by the fact that the blanks are from SAE 1010 steel.

10. Rim for a tubeless wheel for an “off road” vehicle, characterized by the fact of it being obtained by the process as defined in claim 1.

11. Rim for a tubeless wheel for an “off road” vehicle, characterized by the fact of it being obtained by the process as defined in claim 4.

12. Rim for a tubeless wheel for an “off road” vehicle, characterized by the fact of it being obtained by the process as defined in claim 8.

13. Tubeless wheel for an “off road” vehicle, characterized by the fact of it encompassing a rim obtained through the process as defined in claim 1.

14. Tubeless wheel for an “off road” vehicle, characterized by the fact of it encompassing a rim obtained through the process as defined in claim 4.

15. Tubeless wheel for an “off road” vehicle, characterized by the fact of it encompassing a rim obtained through the process as defined in claim 8.
